(19) United States
(12) Patent Application Publication
(10) Pub. No.: US 2011/0135337 A1
(43) Pub. Date: Jun. 9, 2011

(54) Image forming apparatus and method of charging usage fee of image forming apparatus

(75) Inventors: Yuka Saito, Tokyo (JP); Naohiko Kubo, Kanagawa (JP); Daisuke Okada, Kanagawa (JP); Hideaki Matsui, Kanagawa (JP); Nobuhiro Shindo, Tokyo (JP)

(73) Assignee: Ricoh Company, Ltd.

(21) Appl. No.: 12/926,592

(22) Filed: Nov. 29, 2010

(30) Foreign Application Priority Data
Dec. 7, 2009 (JP) 2009-277621

(51) Int. Cl. G03G 21/02

(52) U.S. Cl. 399/79

(57) ABSTRACT

An image forming apparatus counts a number of sheets to be printed with a limited number of colorants or a limited amount of colorant using an other counter that is provided other than a color counter and a monochrome counter. The counter value of the other counter is adjusted using a weighting factor having a value determined based on a number of colors of colorant or an amount of colorant that is used for printing in the economical printing mode, before being added to a counter value of the color counter or the monochrome counter.

### CROSS-REFERENCE TO RELATED APPLICATIONS

This patent application is based on and claims priority under 35 U.S.C. §119 to Japanese Patent Application No. 2009-277621, filed on Dec. 7, 2009, in the Japanese Patent Office, the entire disclosure of which is hereby incorporated herein by reference.

### FIELD OF THE INVENTION

The present invention generally relates to an image forming apparatus and a method of charging usage fee of the image forming apparatus.

### BACKGROUND

The usage fee for using the image forming apparatus such as copier or printer is usually calculated based on a number of pages of document that are copied or printed and a unit charge fee that is previously set for copying or printing one page of document, for example, as described in Japanese Patent Application Publication No. 2006-247988A. More recently, as described in Japanese Patent Application Publication No. 2006-301016A, the usage fee for using the image forming apparatus is calculated based on a specific type of service provided by the image forming apparatus according to a user instruction. For example, Japanese Patent Application Publication No. 2006-301016A sets a unit charge fee respectively for full-color printing and monochrome printing such that the user is charged with higher fee for full-color printing.

In addition to full-color printing and monochrome printing, the recent image forming apparatus is provided with a function of printing a document using a limited number of colors, specifically, using more than one color but less than a number of colors used for full-color printing. In case of printing the document using the limited number of colors, the image forming apparatus described in Japanese Patent Application Publication No. 2006-301016A counts a number of pages of document copied or printed using a limited number of colors, either as a number of pages of document copied or printed in full-color or as a number of pages of document copied or printed in monochrome. Accordingly, the user may be charged with higher fee when the unit charge fee for full-color printing is used, while the user may be charged with lower fee when the unit charge fee for monochrome printing is used.

### SUMMARY

In view of the above, there is a need for a technique of managing a charge fee for using an image forming apparatus even when a document is copied or printed using a printing mode other than the full-color printing mode or the monochrome printing mode.

In one example, an image forming apparatus counts a number of sheets to be printed with a limited number of colors of colorant or a limited amount of colorant using an other counter that is provided other than a color counter and a monochrome counter. The counter value of the other counter is adjusted using a weighting factor having a value determined based on a number of colors of colorant or an amount of colorant that is used for printing in the economical printing mode, before being added to a counter value of the color counter or the monochrome counter.

Example embodiments of the present invention include an image forming apparatus including a color counter to count a number of sheets to be printed in a full-color printing mode to generate a first counter value, a monochrome counter to count a number of sheets to be printed in a monochrome printing mode to generate a second counter value, and an economical counter to count a number of sheets to be printed in an economical printing mode to generate a third counter value. The economical printing mode causes the image forming apparatus to form an image with colorant having a number of colors that is less than a number of colors used for the full-color printing mode or with colorant having an amount less than an amount of colorant used for a printing mode in which the economical printing mode is not set. The image forming apparatus further includes a counter processor to obtain selected one of: a total counter value of the color counter based on the first counter value and the third counter value; and a total counter value of the monochrome counter based on the second counter value and the third counter value. The counter processor obtains the total counter value of the color counter by converting the third counter value to a number of sheets to be printed in the full-color printing mode using a weighting factor having a value determined based on a number of colors of colorant or an amount of colorant that is used for printing in the economical printing mode to generate a converted counter value, and adding the converted counter value to the first counter value. The counter processor obtains the total counter value of the monochrome counter by converting the third counter value to a number of sheets to be printed in the monochrome printing mode using a weighting factor having a value determined based on a number of colors of colorant or an amount of colorant that is used for printing in the economical printing mode to generate a converted counter value, and adding the converted counter value to the second counter value.

Example embodiments of the present invention include a method of managing a charge fee of an image forming apparatus including: counting a number of sheets to be printed in a full-color printing mode using a color counter to generate a first counter value; counting a number of sheets to be printed in a monochrome printing mode using a monochrome counter to generate a second counter value; and counting a number of sheets to be printed in an economical printing mode to generate a third counter value. The economical printing mode causes the image forming apparatus to form an image with colorant having a number of colors that is less than a number of colors used for the full-color printing mode or with colorant having an amount less than an amount of colorant used for a printing mode in which the economical printing mode is not set. The method further includes obtaining selected one of: a total counter value of the color counter based on the first counter value and the third counter value; and a total counter value of the monochrome counter based on the second counter value and the third counter value. The total counter value of the color counter is obtained by converting the third counter value to a number of sheets to be printed in the full-color printing mode using a weighting factor having a value determined based on a number of colors of colorant or an amount of colorant that is used for printing in the economical printing mode to generate a converted counter value, and adding the converted counter value to the first counter value. The total counter value of the monochrome counter is obtained by converting the third counter value to a number of sheets to be printed in the monochrome printing mode using a weighting factor having a value determined based on a number of colors of colorant or an amount of colorant that is used for printing in the economical printing mode to generate a converted counter value, and adding the converted counter value to the second counter value.

In addition to the above-described example embodiments, the present invention may be practiced in various other ways, for example, in the form of a recording medium storing a plurality of instructions which cause a processor to perform the above-described method of managing a charge fee of an image forming apparatus.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a configuration of an image forming system including an image forming apparatus, according to an example embodiment of the present invention;

FIG. 2 is a schematic block diagram illustrating a structure of a controller of the image forming apparatus of FIG. 1;

FIG. 3 is a flowchart illustrating operation of counting a number of pages of document printed using the image forming apparatus of FIG. 1, performed by the image forming apparatus of FIG. 1;

FIG. 4 is a flowchart illustrating operation of applying image processing, performed by the image forming apparatus of FIG. 1 in the operation of FIG. 3;

FIG. 5 is a flowchart illustrating operation of printing a document, performed by the image forming apparatus of FIG. 1 in the operation of FIG. 3;

FIG. 6 is a flowchart illustrating operation of counting a number of pages of document printed in various printing modes using the image forming apparatus of FIG. 1, performed by the image forming apparatus of FIG. 1, according o an example embodiment of the present invention; and

FIG. 7 is an illustration of an example charge fee display mode settings screen, displayed by the image forming apparatus of FIG. 1.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

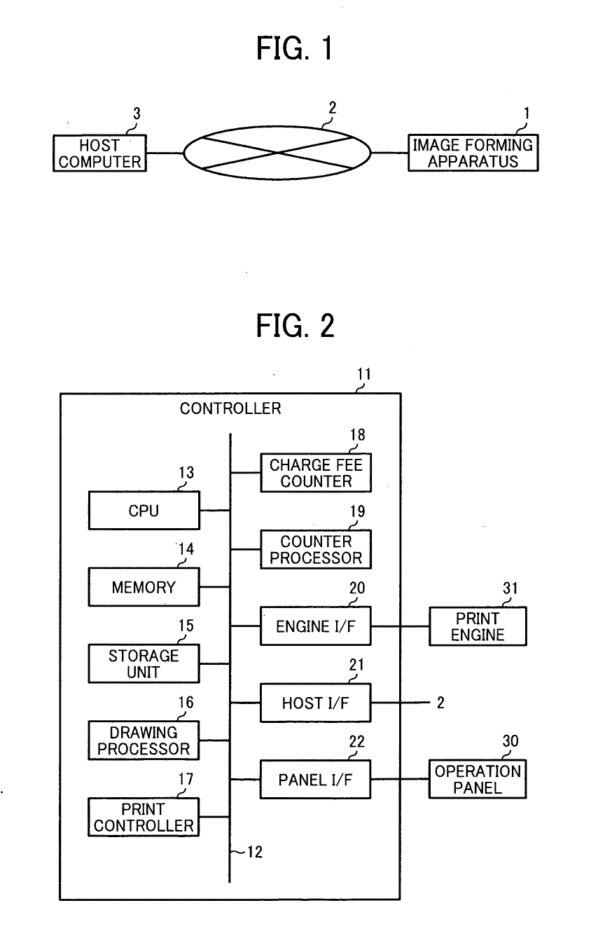

Referring to FIG. 1, an image forming system may be provided, which includes an image forming apparatus 1 that is connected to a host computer 3 through a network 2. The image forming apparatus 1 receives print data including print image data to be printed and print control data, which may be generated using the host computer 3, through the network 2 such as the Internet or a local area network to perform operation of printing an image of the print image data according to the print control data.

The image forming apparatus 1 at least includes a controller 11 of FIG. 2 that controls operation of the image forming apparatus 1. In addition, the image forming apparatus 1 includes a print engine 31 that forms an image of print image data on a recording sheet, and an operation panel 30 that functions as a user interface for interaction with a user. The controller 11 of FIG. 2 includes a central processing unit (CPU) 13, a memory 14, a storage unit 15, a drawing processor 16, a print controller 17, a charge fee counter 18, a counter processor 19, an engine interface (I/F) 20, a host interface (I/F) 21, and a panel interface (I/F) 22, which are connected through a bus 12.

The CPU 13 controls operation of the image forming apparatus 1. For example, the CPU 13 processes print data including print image data and print control data, which is received from the host computer 3, according to a image processing control program stored in the ROM.

The memory 14 includes a program read only memory (ROM), a font ROM, and a random access memory (RAM). The program ROM stores therein the image processing control program that causes the controller 11 to manage data or control operation of peripheral modules to perform image processing operation. The font ROM stores therein various types of font available for printing. The RAM functions as a work memory for the CPU 13, an image buffer that temporarily stores data received from the host computer 3 on the page-by-page basis, or a bit-map memory that converts data stored in the buffer to printing patterns and stores as video data.

The storage unit 15 is implemented by a hard disk drive (HDD) capable of storing a large amount of data including, for example, image data processed by the image forming apparatus 1.

The drawing processor 16 converts the print image data to bit map data, and writes the bit map data onto the memory 14. Further, before storing the print image data, the drawing processor 16 performs color conversion on the print image data from RGB to CMYK. The drawing processor 16 further performs various image processing such as gamma correction and halftone processing on print image data such as the bit map data read out from the memory 14.

The print controller 17 sends the bit map data generated by the drawing processor 16 and the print control data received through the CPU 13 to the engine I/F 20, and instructs the print engine 31 to perform printing. In this example, the print control data indicates a number of pages or sheets to be printed, and a specific mode in which printing is to be performed that may be selected from a plurality of printing modes by default or according to a user instruction. Examples of printing mode include, but not limited to, a full-color printing mode, monochrome printing mode, two-color printing mode, and toner save printing mode (“toner save mode”). The full-color printing mode is a printing mode in which a document is printed in full-color using all of C, M, Y, and K toner. The monochrome printing mode is a printing mode in which a document is printed in monochrome using only K toner. The two-color printing mode is a printing mode in which only two colors selected from C, M, Y, and K are used for printing. The toner save mode is a printing mode in which less toner is used for printing. For the descriptive purposes, in this example, these printing modes are generally classified into three types of printing modes including the full-color printing mode, the monochrome printing mode, and an economical printing mode. In this example, the economical printing mode includes the two-color printing mode and the toner save mode. However, any other printing mode may be classified into the economical printing mode as long as the usage of toner required for printing is reduced either by reducing a number of colors of toner or an amount of toner being consumed.

The charge fee counter 18 counts a number of pages of document to be printed for each printing mode as a counter value, based on the result output from the CPU 13. More specifically, in this example, the charge fee counter 18 is provided with at least three internal counters including a color charge fee counter, a monochrome charge fee counter, and an economical (Eco) charge fee counter.

The counter processor 19 obtains a counter value indicating a number of pages of document to be printed for each printing mode that is counted by the charge fee counter 18, performs calculation on the obtained counter value, and sends the calculated result to the operation panel OF 22. Based on the calculated result of the counter processor 19, the CPU 13 may further calculate a charge fee for printing a document in a specific printing mode, using either one of a unit charge fee previously set for full-color printing and a unit charge fee previously set for monochrome printing.

More specifically, in this example, while the charge fee counter 18 is provided with three internal counters including the color charge fee counter, monochrome charge fee counter, and Eco charge fee counter, the image forming apparatus 1 is previously set such that the counter processor 19 calculates a charge fee for printing based on a unit charge fee that is set for color printing or monochrome printing. Accordingly, the counter processor 19 converts the counter value of the Eco charge fee counter that is obtained for economical printing to a counter value of either one of the color charge fee counter and the monochrome charge fee counter. With this conversion, the counter processor 19 is able to calculate a charge fee for printing a document in the economical printing mode even when there is no unit charge fee specifically set for economical printing.

Further, in this example, the functions respectively performed by the charge fee counter 18 and the counter processor 19 are performed under control of the CPU 13, upon loading a charge fee management program that may be stored in a desired memory such as the ROM of the memory 14. Upon execution of the CPU 13, the CPU 13 loads the charge fee management program stored in the ROM of the memory 14 onto the RAM of the memory 14 to cause the CPU 13 to function as the charge fee counter 18 and the counter processor 19. Alternatively, the charge fee management program may be stored in any desired removable medium or any storage device provided on the network 2 for distribution.

Still referring to FIG. 2, the engine I/F 20 functions as an interface between the controller 11 and the print engine 31. For example, the engine I/F 20 sends a control signal used for controlling the print engine 31 to the print engine 31, or receives a status signal indicating the status of the print engine 31 from the print engine 31.

The host I/F 21 functions as an interface between the image forming apparatus 1 and the host computer 3. For example, the host I/F 21 receives print data sent from the host computer 3 through the network 2, or sends a status signal indicating the status of the image forming apparatus 1 to the host computer 3 through the network 2.

The panel I/F 22 functions as an interface between the controller 11 and the operation panel 30. For example, the panel I/F 22 sends a signal that indicates the status of the image forming apparatus 1, a current mode of the image forming apparatus 1, or a font to be used by the image forming apparatus 1, which may be used to generate a screen to be displayed on the operational panel 30. In this example, the operation panel 30 is provided with a display such as a liquid crystal display (LCD) for displaying various information to the user at the image forming apparatus 1, and various keys or buttons that allow the user to input a user instruction. Additionally or alternatively, the operation panel 30 may be implemented by a display functioning as a touch panel screen.

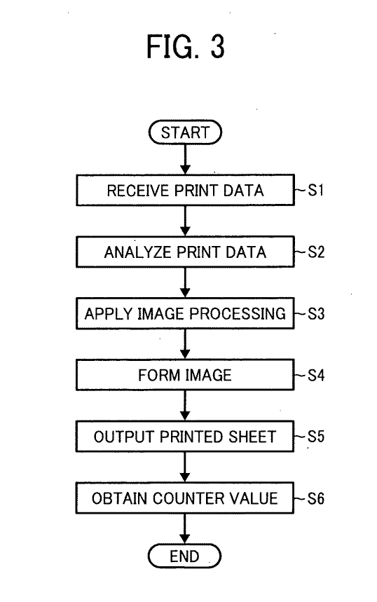

Referring to FIG. 3, operation of counting a number of pages of document that are printed using the image forming apparatus 1, performed by the image forming apparatus 1 under control of controller 11, is explained according to an example embodiment of the present invention.

At S1, the host I/F 21 receives print data from the host computer 3 through the network 2, and sends the print data to the CPU 13.

At S2, the CPU 13 analyzes the print data received from the host I/F 21 to divide the print data into print image data and print control data.

At S3, the drawing processor 16 converts the print image data to bit map data, and applies image processing to the bit map data to generate processed image data.

At S4, the print controller 17 sends the processed image data via the engine I/F 20 to the print engine 31, and instructs the print engine 31 to form an image of the print image data onto a recording sheet.

At S5, the print controller 17 instructs the print engine 31 through the engine I/F 20 to discharge the recording sheet on which a toner image of the print image data is formed, from the image forming apparatus 1.

At S6, the charge fee counter 18 and the counter processor 19 obtain a counter value related to printing, and the operation ends.

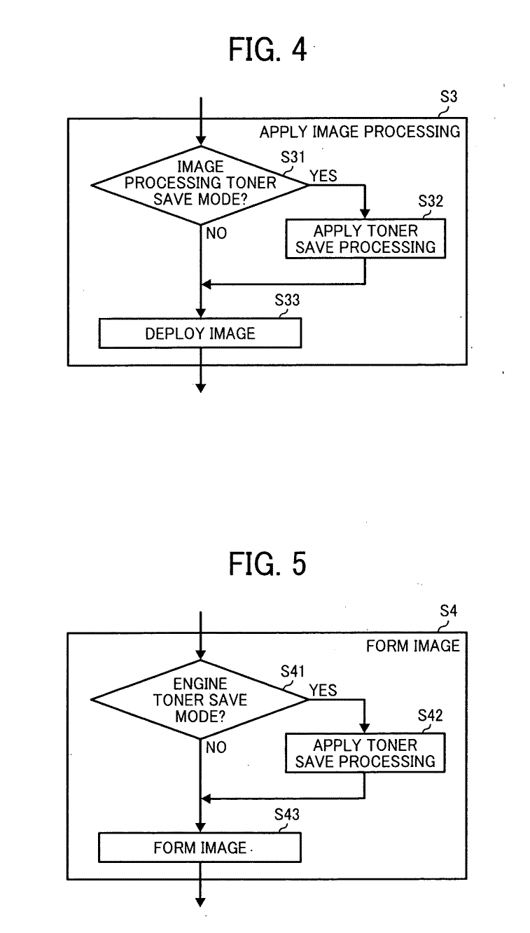

FIG. 4 illustrates example operation of applying image processing to print image data, which may be performed at S3 of FIG. 3.

At S31, the drawing processor 16 determines whether the print image data is to be printed in the toner save mode. For example, the drawing processor 16 determines whether the print control data, which is obtained at S2, instructs to print the print image data in the toner save mode.

When it is determined that the print image data is to be printed in the toner save mode (“YES” at S31), the operation proceeds to S32 to apply image processing specially designed for toner save mode (“toner save processing”) to the print image data, and to S33 to deploy the processed print image data in bit-map format. Examples of image processing designed for toner save mode include, but not limited to, gamma correction using a gamma value that is adjusted for toner save processing that is applied at the time of deploying image data.

For example, the user at the host computer 3 may instruct the image forming apparatus 1 to print a document in the toner save mode by selecting the toner save mode through a settings screen such as property dialog. The host computer 3 generates print control data that indicates selection of the toner save mode, and sends the print control data to the image forming apparatus 1. At this time, the user may set a specific value of toner save rate indicating the amount of toner usage in toner save mode compared with the amount of toner usage in full-color printing mode or monochrome printing mode. Alternatively, the toner save rate may be set by default.

When the image forming apparatus 1 determines that the document is to be printed in the toner save mode according to the print control data, the drawing processor 16 applies toner save processing to the print image data, specifically, by reducing overall toner density of the print image data. For example, the drawing processor 16 converts a pixel value of the print image data using the equation: PV2=PV1*(100−sv)/100, wherein PV2 is a pixel value of print image data after toner save processing is applied, PV1 is an original pixel value of print image data, and sv is a toner save rate expressed in percentage. In alternative to calculating using the equation, the drawing processor 16 may convert a pixel value of the print image data using a toner save table that stores the processed pixel values of print image data in association with the unprocessed pixel values of print image data.

Alternatively, the drawing processor 16 may convert a pixel value of the print image data to reduce overall toner density of the print image data, by performing gamma correction using a gamma table prepared for toner save mode in alternative to using a gamma table that is usually used. The toner save gamma table may be generated by multiplying the normal table with a predetermined coefficient, which is less than 1.

When it is determined that the print image data is not to be printed in the toner save mode (“NO” at S31), the operation proceeds to S33 to deploy the print image data in bit-map format without applying toner save processing.

FIG. 5 illustrates example operation of forming an image of print image data, which may be performed at S4 of FIG. 3.

At S41, the print engine 31 determines whether the print image data is to be printed in the toner save mode. For example, the print engine 31 determines whether the print control data, which is obtained at S2, instructs to print the print image data in the toner save mode.

When it is determined that the print image data is to be printed in the toner save mode (“YES” at S41), the operation proceeds to S42 to apply image processing specially designed for toner save mode (“toner save processing”) to the print image data, and to S43 to form an image of the processed print image data on a recording sheet. Examples of image processing designed for toner save mode include, but not limited to, gamma correction using a gamma value that is adjusted for toner save processing that is applied at the time of image formation, and reducing a number of dots of the print image data at the time of image formation.

When it is determined that the print image data is not to be printed in the toner save mode (“NO” at S41), the operation proceeds to S43 to form an image of print image data on a recording sheet without applying toner save processing.

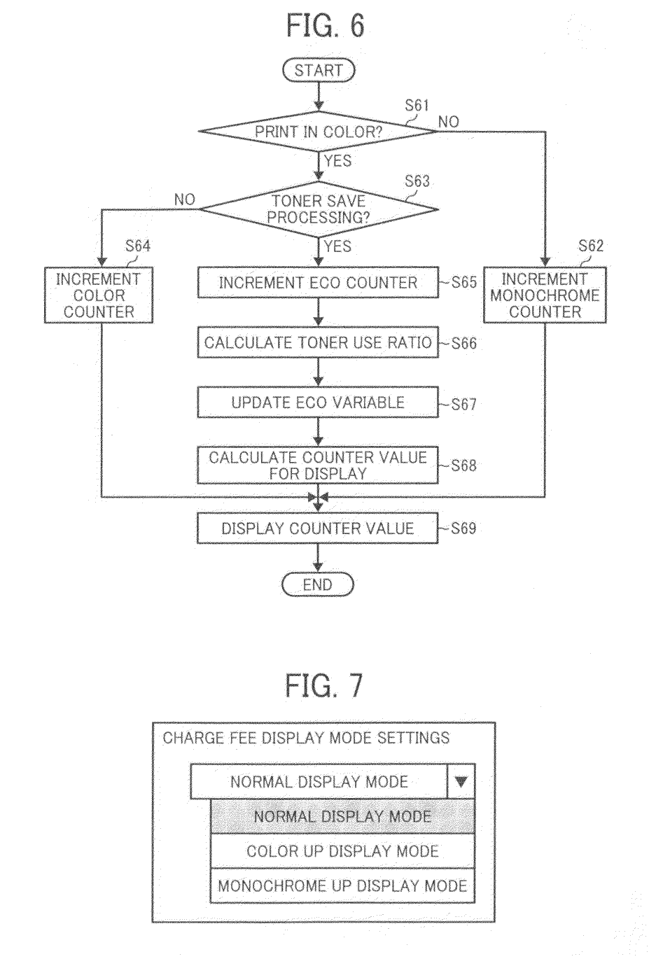

Referring now to FIG. 6, operation of obtaining a counter value related to printing of print image data, performed at of S6 of FIG. 3, is explained.

At S61, the charge fee counter 18 determines whether the print image data is to be printed in color or monochrome to generate a determination result. For example, the charge fee counter 18 may determine whether the print image data is to be printed in color or monochrome according to the print control data obtained at S2 of FIG. 3. Alternatively, the charge fee counter 18 may determine whether the print image data is to be printed in color or monochrome according to a type of print image data to be printed such as whether the print image data is color or monochrome.

When the determination result indicates that the print image data is to be printed in monochrome (“NO” at S61), the operation proceeds to S62. At S62, the charge fee counter 18 increments the counter value of the monochrome charge fee counter by a predetermined number. The accumulated counter value of the monochrome charge fee is stored in the memory 14. At S69, the panel I/F 22 causes the operation panel 30 to display information based on the counter value of the monochrome charge fee counter.

When the determination result indicates that the print image data is to be printed in color (“YES” at S62), the operation proceeds to S63 to determine whether the print image data is to be printed in toner save mode. More specifically, the CPU 13 determines whether S32 of FIG. 4 or S42 of FIG. 5 is performed. When it is determined that the print image data is not to be printed in toner save mode (“NO” at S63), the operation proceeds to S64 to increment the counter value of the color charge fee counter by a predetermined number. The accumulated counter value of the color charge fee counter is stored in the memory 14. At S69, the panel I/F 22 causes the operation panel 30 to display information based on the counter value of the color charge fee counter.

When it is determined that the print image data is to be printed in toner save mode (“YES” at S63), the operation proceeds to S65 to increment the counter value of the Eco charge fee counter by a predetermined number. The accumulated counter value of the Eco charge fee counter is stored in the memory 14.

Specifically, in this example, the number of incrementing any one of the internal counters of the charge fee counter 18 is determined based on a number of pages or sheet to be printed, which may be obtainable from the print control data.

Since the image forming apparatus 1 is only capable of charging the usage fee using either a unit charge fee for full-color printing or a unit charge fee for monochrome printing, the counter value of the Eco charge fee counter needs to be converted to either one of the counter value of the color charge fee counter and the counter value of the monochrome charge fee counter. In this example, the controller 11 determines whether to treat the counter value of the Eco charge fee counter as the counter value of the color charge fee counter or the counter value of the monochrome charge fee counter based on a user instruction specifying a charge fee display mode. For example, the operation panel 30 or the host computer 3 displays a settings screen illustrated in FIG. 7 on its display, and allows the user to select one of the display modes. The panel I/F 22 or the host IN 21 stores information regarding the selected one of the display modes in the memory 14. With this information regarding the selected display mode, the counter processor 19 calculates a counter value of the charge fee counter 18 based on the counter value of the Eco charge fee counter.

Further, in this example, before adding the counter value of the Eco charge fee counter to either one of the counter value of the color charge fee counter and the counter value of the monochrome charge fee counter, the counter processor 19 weighs the counter value of the Eco charge fee counter based on the toner save ratio such that the charge fee correctly reflects a number of pages or sheets of document printed in toner save mode.

More specifically, when the display mode is set to the color up display mode, the counter value of the Eco charge fee counter is added to the counter value of the color charge fee counter, after adjusting with the toner save ratio. When the display mode is set to the monochrome up display mode, the counter value of the Eco charge fee counter is added to the counter value of the monochrome charge fee counter, after adjusting with the toner save ratio. When the display mode is set to the normal display mode, the counter value of the Eco charge fee counter is added to the counter value of the color charge fee counter, without adjusting with the toner save ratio.

Referring back to FIG. 6, at S66, the counter processor 19 calculates the toner usage ratio Tsv, for example, using the following equation.

Tsv=T*(1−sv1/100)*(1−sv2/100), wherein T is a usage ratio of toner when the toner save mode is not set, sv1 is a toner save rate of toner save processing applied at the time of deploying image data expressed in percentage, and sv2 is a toner save rate of toner save processing at the time of forming an image of print image data expressed in percentage. In this example, any one of the toner save rate sv1 and the toner save rate sv2 may be determined according to a user instruction input by the user, or set by default.

At S67, the counter processor 19 updates an Eco variable based on the toner usage ratio obtained at S66. In this example, the Eco variable is the counter value of the Eco charge fee counter that reflects a number of pages or sheets of document printed in toner save mode, which may be obtained from the memory 14. More specifically, assuming that the Eco variable that is obtained from the memory 14 is E, the updated Eco variable Esv that is updated based on the toner usage ratio Tsv is obtained by the following equation.

Esv=E+{α+Tsv*(1−α)}, wherein α is a predetermined constant value.

At S68, the CPU 13 adds the Eco variable, which is the weighted counter value of the Eco charge fee counter that is weighted using the toner save ratio, to selected one of the counter value of the color charge fee counter and the counter value of the monochrome charge fee counter.

When the display mode is set to the color up display mode, the counter value of the color charge fee counter is obtained by adding the updated Eco variable Esv obtained at S67 to the counter value of the color charge fee counter obtained from the memory 14.

When the display mode is set to the monochrome up display mode, the counter processor 19 further multiplies the updated Eco variable Esv obtained at S67 with the ratio between the unit charge fee for full-color printing and the unit charge fee for monochrome printing to obtain the multiplied value. The counter processor 19 then adds the multiplied value to the counter value of the monochrome charge fee counter to obtain a counter value of the monochrome charge fee counter used for charge fee determination.

At S69, the panel I/F 22 or the host I/F 21 causes the operation panel 30 or the host computer 3 to display information based on the counter values of the charge fee counter 18.

More specifically, when the display mode is set to the color up display mode, the operation panel 30 or the host computer 3 displays the counter value of the color charge fee counter, which is calculated by the counter processor 19 based on the Eco variable updated based on the toner save ratio, as the counter value of the color charge fee counter used for charge fee determination using a unit charge fee for color printing. Further, the operation panel 30 or the host computer 3 may display the counter value of the monochrome charge fee counter, which is obtained by the monochrome charge fee counter of the charge fee counter 18, for charge fee determination using a unit charge fee for monochrome printing.

When the display mode is set to the monochrome up display mode, the operation panel 30 or the host computer 3 displays the counter value of the monochrome charge fee counter, which is calculated by the counter processor 19 based on the Eco variable updated based on the toner save ratio, as the counter value of the monochrome charge fee counter for charge fee determination using a unit charge fee for monochrome printing. Further, the operation panel 30 or the host computer 3 may display the counter value of the color charge fee counter, which is obtained by the color charge fee counter of the charge fee counter 18, for charge fee determination using a unit charge fee for color printing.

When the normal counter mode is selected, the operation panel 30 or the host computer 3 displays the counter value of the color charge fee counter, which is obtained by the counter processor 19 by adding the counter value of the Eco charge fee counter with the counter value of the color charge fee counter, as the counter value of the color charge fee counter for charge fee determination using a unit charge fee for color printing. Further, the operation panel 30 or the host computer 3 may display the counter value of the monochrome charge fee counter, which is obtained by the monochrome charge fee counter of the charge fee counter 18, for charge fee determination using a unit charge fee for monochrome printing.

For the descriptive purposes, it is assumed that the image forming apparatus 1 is previously set with a unit charge fee of 50 cents for full-color printing, and a unit charge fee of 10 cents for monochrome printing. Further, it is assumed that the image forming apparatus 1 prints 10 pages of document in full-color printing and toner save modes, with a toner save rate sv1 of 20% for image processing and a toner save rate sv2 of 10% for printing. Further, the toner usage ratio of toner used when the toner save mode is not set is 1, and the constant value α is set to 0.2.

As described above referring to S66 to S69, the counter processor 19 calculates the toner usage ratio Tsv as follows.

Tsv=T*(1−sv1/100)*(1−sv2/100)=1*(1−20/100)*(1−10/100)=0.72.

The counter processor 19 calculates the updated Eco variable Esv as follows.

Esv=E+{α+Tsv(1−α)}=10+{0.2+0.72*(1−0.2)}=10.776.

In case of color-up display mode, the counter value Ctotal of the color charge fee counter is obtained by adding the updated Eco variable 10.776 with the counter value C of the color charge fee counter, as follows.

Ctotal=C+10.776

In this example, when the obtained counter value is not integer, the decimal points are ignored such that the above-described counter value Ctotal is expressed as C+10.

In case of monochrome up display mode, the counter value Btotal of the monochrome charge fee counter is obtained by adding the updated Eco variable 10.776 that is multiplied by the ratio of the color unit charge fee with the monochrome unit charge fee 50/10, with the counter value B of the monochrome charge fee counter, as follows.

Btotal=B+10.776*50/10=B+53.88

In this example, when the obtained counter value is not integer, the decimal points are ignored such that the above-described counter value Btotal is expressed as B+53.

In the above-described example, the counter processor 19 calculates the updated Eco variable based on the toner save ratio using the equation. Alternatively, the counter processor 19 may store a look up table that stores a set of updated Eco variable value and a toner save ratio value in the memory 14. As long as the toner save ratio, or the toner save rate, is available, the counter processor 19 may refer to the look up table to obtain the updated Eco variable.

As described above referring to FIG. 6, the counter processor 19 adjusts the counter value of the charge fee counter 18 for the color up display mode or the monochrome up display mode, by adding or subtracting the weighted Eco counter value from at least one of the color charge fee counter value and the monochrome charge fee counter value. Since the counter value of the color charge fee counter and the counter value of the monochrome charge fee counter are respectively retained in the memory 14, these counter values are kept the same even when the display mode is switched from one to another.

As described above, the image forming apparatus 1 is provided with a function of adjusting a counter value of the Eco charge fee counter of the charge fee counter 18 that corresponds to economical printing, according to the toner usage ratio. More specifically, in case of printing a document in full-color printing and toner save modes and displaying the counter value in color up display mode, the counter value of the Eco charge fee counter is incremented. The counter value of the Eco charge fee counter is adjusted using the toner save ratio to generate a weighted counter value of the Eco charge fee counter. The image forming apparatus 1 adds the weighted counter value of the Eco charge fee counter to the counter value of the color charge fee counter for display in color up display mode. In this manner, the image forming apparatus 1 is able to obtain and display information regarding a charge fee for printing a document in toner save mode according to the toner save ratio, using the color charge fee counter. Since the counter value of the Eco charge fee counter, or the Eco variable, is updated based on the toner save ratio that reflects an amount of toner used for printing, the resultant charge fee for printing a document can be calculated with the improved accuracy even when printing other than the full-color printing and monochrome printing is performed.

Alternatively, in case of printing a document in full-color printing and toner save modes and displaying the counter value in monochrome up display mode, the counter value of the Eco charge fee counter is incremented. The counter value of the Eco charge fee counter is adjusted using the toner save ratio to generate a weighted counter value of the Eco charge fee counter. The image forming apparatus 1 adds a value of the weighted counter value of the Eco charge fee counter that is multiplied with the ratio between a unit charge fee for full-color printing and a unit charge fee for monochrome printing, to the counter value of the monochrome charge fee counter, for display in monochrome up display mode using the monochrome charge fee counter. In this manner, the image forming apparatus 1 is able to obtain and display information regarding a charge fee for printing a document in toner save mode according to the toner save ratio, using the monochrome charge fee counter. Since the counter value of the Eco charge fee counter, or the Eco variable, is updated based on the toner save ratio that reflects an amount of toner used for printing, the resultant charge fee for printing a document can be calculated with the improved accuracy even when printing other than the full-color printing and monochrome printing is performed.

Further, as described above throughout the specification, the charge fee counter 18 and the counter processor 19 are provided within the image forming apparatus 1 such that a management server does not have to be provided on the network 2 to perform charge fee calculation. Further, since the image forming apparatus is able to perform charge fee calculation without any access to the network 2, the image forming apparatus that is not capable of communicating via network may be used in alternative to the image forming apparatus 1 of FIG. 1. In such case, however, it is assumed that the image forming apparatus 1 copies a document according to a user instruction received from the operation panel 30, or prints print image data obtained from its internally memory such as the storage unit 15.

More specifically, by installing the charge fee management program that additionally adds the charge fee counter 18 and the counter processor 19 onto any desired image forming apparatus, the image forming apparatus installed with such management program is able to calculate a charge fee for economical printing with improved accuracy, even only when a unit charge fee for full-color printing or a unit charge fee for monochrome printing is available.

Further, in any one of the above-described examples, the example case of using the toner save mode as the economical printing is described. Additionally or alternatively, any other printing mode may be used for economical printing such a two color printing mode in which a limited number of colors of toner is used for printing. In case of printing with the two color printing mode, the Eco variable, which is the counter value of the Eco charge fee counter, is updated according to the toner save ratio that may be obtainable from a ratio of a number of colors used for printing in two color printing mode with respect to a number of colors used for printing in full-color printing mode.

Further, in the above-described example, it is assumed that the image forming apparatus forms an image using toner. Alternatively, any other type of colorant may be used to form an image such as ink.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, involatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

In one example, the present invention may reside in an image forming apparatus capable of printing a document in various printing modes including a full-color printing mode, monochrome printing mode, and color printing mode. The image forming apparatus is previously set with a unit charge fee for printing a document in the full-color printing mode and a unit charge fee for printing a document in the monochrome printing mode. The image forming apparatus includes: first counting means for counting a number of sheets of document printed in the full-color printing mode; second counting means for counting a number of sheets of document printed in the monochrome printing mode; and third counting means for counting a number of sheets of document printed in the color printing mode. The image forming apparatus further includes means for converting a counter value of the third counting means to a counter value of selected one of a number of sheets of document printed in the full-color printing mode and a number of sheets of document printed in the monochrome printing mode according to a number of colors of colorant or an amount of colorant that is used for printing to generate a converted counter value; and means for adding the converted counter value of the converting means to selected one of the counter value of the first counting means and the counter value of the second counting means. The color printing mode is a printing mode in which a number of colors of colorant used for printing is less than a number of colors of colorant used for full-color printing or an amount of colorant used for printing is less than an amount of colorant used for full-color printing.

In the above-described example, the image forming apparatus further includes means for displaying the counter value of the first counting means and means for displaying the counter value of the second counting means.

In the above-described example, the image forming apparatus further includes means for selecting one of a number of sheets of document printed in the full-color printing mode and a number of sheets of document printed in the monochrome printing mode of the converting means, and selecting one of the counter value of the first counting means and the counter value of the second counting means of the adding means, according to a user instruction.

In the above-described example, the means for converting a counter value of the third counting means to a counter value of selected one of a number of sheets of document printed in the full-color printing mode and a number of sheets of document printed in the monochrome printing mode, according to a reduction ratio of colorant that is reduced in the color printing mode with respect to an amount of colorant used for printing in the full-color printing mode.

More specifically, in case of printing a document in full-color printing and toner save modes, the counter value of the economical counter is incremented. The counter value of the economical counter is converted to a counter value that reflects the toner usage ratio. In case of displaying in a color up display mode, the converted counter value is added to the counter value of the color counter for display in the color up display mode. In case of displaying in a monochrome up display mode, the converted counter value is multiplied with a ratio of a unit charge fee for full-color printing with respect to a unit charge fee for monochrome printing to generate a multiplied value. The multiplied value is further added to the counter value of the monochrome counter for display in the monochrome up display mode using the monochrome counter.

In one example, the present invention may reside in a method of managing a charge fee of an image forming apparatus capable of printing a document in various printing modes including a full-color printing mode, monochrome printing mode, and color printing mode. The image forming apparatus is previously set with a unit charge fee for printing a document in the full-color printing mode and a unit charge fee for printing a document in the monochrome printing mode. The charge fee managing method includes: counting a number of sheets of document printed in the full-color printing mode to generate a first counter value; counting a number of sheets of document printed in the monochrome printing mode to generate a second counter value; and counting a number of sheets of document printed in the color printing mode to generate a third counter value. The charge fee managing method further includes: converting the third counter value to a counter value of selected one of a number of sheets of document printed in the full-color printing mode and a number of sheets of document printed in the monochrome printing mode according to a number of colors of colorant or an amount of colorant that is used for printing to generate a converted counter value; and adding the converted counter value to selected one of the first counter value and the second counter value. The color printing mode is a printing mode in which a number of colors of colorant used for printing is less than a number of colors of colorant used for full-color printing or an amount of colorant used for printing is less than an amount of colorant used for full-color printing.

In another example, the present invention may reside in a recording medium storing a plurality of instructions which cause a computer to perform the above-described charge fee managing method.

What is claimed is:

1. An image forming apparatus, comprising:
a charge fee counter unit including:
a color counter configured to count a number of sheets to be printed in a full-color printing mode to generate a first counter value;
a monochrome counter configured to count a number of sheets to be printed in a monochrome printing mode to generate a second counter value; and
an economical counter configured to count a number of sheets to be printed in an economical printing mode to generate a third counter value, wherein the economical printing mode causes the image forming apparatus to form an image with colorant having a number of colors that is less than a number of colors used for the full-color printing mode or with colorant having an amount less than an amount of colorant used for a printing mode in which the economical printing mode is not set; and
a counter processor configured to obtain selected one of: a total counter value of the color counter based on the first counter value and the third counter value; and a total counter value of the monochrome counter based on the second counter value and the third counter value, wherein
the counter processor obtains the total counter value of the color counter by converting the third counter value to a number of sheets to be printed in the full-color printing mode using a weighting factor having a value determined based on a number of colors of colorant or an amount of colorant that is used for printing in the economical printing mode to generate a converted counter value, and adding the converted counter value to the first counter value, and
the counter processor obtains the total counter value of the monochrome counter by converting the third counter value to a number of sheets to be printed in the monochrome printing mode using a weighting factor having a value determined based on a number of colors of colorant or an amount of colorant that is used for printing in the economical printing mode to generate a converted counter value, and adding the converted counter value to the second counter value.

2. The image forming apparatus of claim 1, further comprising:
a display unit configured to display at least one of the total counter value of the color counter and the total counter value of the monochrome counter.

3. The image forming apparatus of claim 1, further comprising:
an interface unit configured to receive a user instruction input by a user, wherein the counter processor determines whether to obtain the total counter value of the color counter or the total counter value of the monochrome counter according to the user instruction.

4. The image forming apparatus of claim 1, wherein the value of the weighting factor is determined based on a reduction ratio of colorant that is reduced in the economical printing mode with respect to an amount of colorant used for printing in the full-color printing mode.

5. A method of managing a charge fee of an image forming apparatus, the method comprising:
counting a number of sheets to be printed in a full-color printing mode using a color counter to generate a first counter value;
counting a number of sheets to be printed in a monochrome printing mode using a monochrome counter to generate a second counter value;
counting a number of sheets to be printed in an economical printing mode to generate a third counter value, wherein the economical printing mode causes the image forming apparatus to form an image with colorant having a number of colors that is less than a number of colors used for the full-color printing mode or with colorant having an amount less than an amount of colorant used for a printing mode in which the economical printing mode is not set; and
obtaining selected one of: a total counter value of the color counter based on the first counter value and the third counter value; and a total counter value of the monochrome counter based on the second counter value and the third counter value, wherein
the total counter value of the color counter is obtained by converting the third counter value to a number of sheets to be printed in the full-color printing mode using a weighting factor having a value determined based on a number of colors of colorant or an amount of colorant that is used for printing in the economical printing mode to generate a converted counter value, and adding the converted counter value to the first counter value, and
the total counter value of the monochrome counter is obtained by converting the third counter value to a number of sheets to be printed in the monochrome printing mode using a weighting factor having a value determined based on a number of colors of colorant or an amount of colorant that is used for printing in the economical printing mode to generate a converted counter value, and adding the converted counter value to the second counter value.

6. The method of claim 5, further comprising:
displaying at least one of the total counter value of the color counter and the total counter value of the monochrome counter.

7. The method of claim 5, further comprising:
receiving a user instruction input by a user; and
determining whether to obtain the total counter value of the color counter or the total counter value of the monochrome counter according to the user instruction.

8. The method of claim 5, further comprising:
determining the value of the weighting factor based on a reduction ratio of colorant that is reduced in the economical printing mode with respect to an amount of colorant used for printing in the full-color printing mode.

9. A recording medium storing a plurality of instructions which cause a processor, when executed, to perform a method of managing a charge fee of an image forming apparatus, the method comprising:
counting a number of sheets to be printed in a full-color printing mode using a color counter to generate a first counter value;
counting a number of sheets to be printed in a monochrome printing mode using a monochrome counter to generate a second counter value;
counting a number of sheets to be printed in an economical printing mode to generate a third counter value, wherein the economical printing mode causes the image forming apparatus to form an image with colorant having a number of colors that is less than a number of colors used for the full-color printing mode or with colorant having an amount less than an amount of colorant used for a printing mode in which the economical printing mode is not set; and
obtaining selected one of: a total counter value of the color counter based on the first counter value and the third counter value; and a total counter value of the monochrome counter based on the second counter value and the third counter value, wherein
the total counter value of the color counter is obtained by converting the third counter value to a number of sheets to be printed in the full-color printing mode using a weighting factor having a value determined based on a number of colors of colorant or an amount of colorant that is used for printing in the economical printing mode to generate a converted counter value, and adding the converted counter value to the first counter value, and
the total counter value of the monochrome counter is obtained by converting the third counter value to a number of sheets to be printed in the monochrome printing mode using a weighting factor having a value determined based on a number of colors of colorant or an amount of colorant that is used for printing in the economical printing mode to generate a converted counter value, and adding the converted counter value to the second counter value.
